(19) United States
(12) Patent Application Publication
(10) Pub. No.: US 2011/0216266 A1
(43) Pub. Date: Sep. 8, 2011

(54) WEDGE BACKLIGHT WITH DIFFRACTION GRATING

(75) Inventor: Adrian Travis, Seattle, WA (US)

(73) Assignee: MICROSOFT CORPORATION, Redmond, WA (US)

(21) Appl. No.: 12/780,671

(22) Filed: May 14, 2010

Related U.S. Application Data
(60) Provisional application No. 61/309,696, filed on Mar. 2, 2010.

(51) Int. Cl. G02F 1/1335; F21V 7/22

(52) U.S. Cl. 349/62; 362/613

(57) ABSTRACT

Embodiments are disclosed herein that relate to backlighting a display panel comprising color filters via an optical wedge. For example, one disclosed embodiment provides a display panel comprising a plurality of pixels, and also comprising an optical wedge disposed optically upstream of the display panel such that light emerging from the light output interface backlights the display panel. The display system further comprises one or more light sources configured to introduce light into the optical wedge, and a diffraction grating disposed optically between the light sources and the display panel.

### CROSS REFERENCE TO RELATED APPLICATIONS

This application claims priority to U.S. Provisional Application No. 61/309,696, filed Mar. 2, 2010, the entirety of which is hereby incorporated herein by reference.

### BACKGROUND

An optical wedge is a wedge-shaped light guide configured to transmit light between a first light interface located at an end of the light guide and a second light interface located at a major surface of the light guide via total internal reflection. Light input into the first light interface within a suitable range of input angles propagates through the optical wedge until the critical angle of internal reflection is reached, thereby allowing collimated light to be transmitted through the second interface. Depending upon the design of a particular optical wedge, the first light interface may be either at a thin end or a thick end of the optical wedge, and light may or may not travel a folded path within the optical wedge. In either case, the internal reflection of light within the optical wedge allows light to fan out to a desired beam size within a relatively small volume of space, and therefore may permit the construction of a relatively compact optical system compared to a similar system without an optical wedge.

### SUMMARY

Various embodiments are disclosed herein that relate to backlighting a display panel comprising color filters via an optical wedge. For example, one disclosed embodiment provides a display panel comprising a plurality of pixels, and also comprising an optical wedge disposed optically upstream of the display panel such that light emerging from the light output interface backlights the display panel. The display system further comprises one or more light sources configured to introduce light into the optical wedge, and a diffraction grating disposed optically between the light sources and the display panel.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic depiction of an embodiment of an optical wedge backlighting system providing light to an LCD panel.

FIG. 2 shows a magnified, schematic view of an embodiment of an optical wedge backlighting system comprising a diffraction grating.

FIG. 3 shows a magnified, schematic view of another embodiment of an optical wedge backlighting system comprising a diffraction grating.

FIG. 4 shows a magnified, schematic view of another embodiment of an optical wedge backlighting system comprising a diffraction grating.

FIG. 5 shows a flow diagram depicting an embodiment of a method of operating a display panel system.

### DETAILED DESCRIPTION

One potential use for an optical wedge is as a collimating backlight for a liquid crystal display (LCD) panel or other such light valve system. In such a system, a LCD panel or other display panel may be arranged such that light exiting the optical wedge via the major surface light interface is directed through the panel. One or more light sources, such as light-emitting diodes (LEDs), can be arranged along the end light interface to input light into the optical wedge, thereby allowing the cross-sectional area of the light to fan out to the width of the LCD panel before exiting the major surface of the wedge.

LCD panels and other such display panel systems may include color filters in each pixel to enable the display of color images. Where an LCD panel is illuminated with white light, these color filters absorb colors other than the color of that particular filter, and thereby attenuate an intensity of light passing through the filters relative to an intensity of light incident on the filters. This may reduce image brightness. In a wedge backlight system, one potential solution to this issue is to use a plurality of horizontally-arranged colored LEDs (e.g. one or more each of red, green and blue LEDs) as light sources at the end light interface of the optical wedge. The LEDs may be positioned such that rays of colored light from the LEDs emerge from the optical wedge in such locations that they can be directed through corresponding color filters. This may help to preserve the intensity of light passing from the backlight system that passes through the LCD panel. However, color LEDs may be more expensive than white LEDs of similar power.

Further, such color filters are sometimes arranged in columns that run parallel to a short dimension of a rectangular LCD panel. Where an optical wedge is arranged such that the taper of the wedge runs in a direction parallel to a long dimension of the LCD panel, the LEDs may form bands of light that run along the long dimension of the LCD panel, rather than along the short dimension. As a result, the colored light bands run in directions perpendicular to the color filters.

Accordingly, various embodiments are disclosed herein that employ a diffraction grating to separate white light output from an optical wedge into bands of colored light for focusing through corresponding color filters of a display panel. Further, as described below, a diffraction grating also may be used to reduce optical aberration in an optical wedge-based backlight system that utilizes colored light sources. While described herein in the context of an LCD display system with an LCD panel, it will be understood that any other suitable type of display panel may be used.

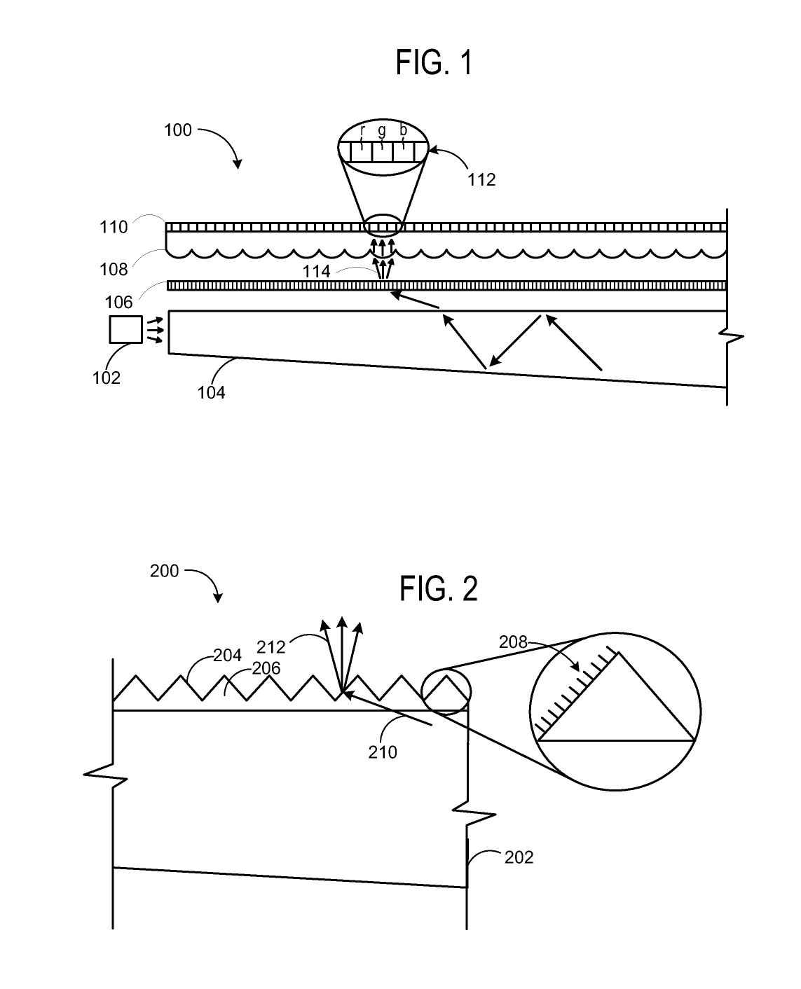

FIG. 1 shows a schematic depiction of an embodiment of such an LCD display system 100. LCD display system 100 comprises a light source 102, an optical wedge 104, a diffraction grating 106, and an LCD panel system that comprises a lens array 108 configured to direct light through the pixels of a display panel 110. FIG. 1 also illustrates an arrangement of color filters 112 of display panel 110. In the embodiment of FIG. 1, the color filters 112 run in columns oriented normal to a plane of the page, while the optical wedge has a direction of taper that is parallel to the plane of the page. It will be understood that such color filters may be omitted in embodiments that utilize colored light sources. The terms “optically upstream” and “optically downstream” are used herein to describe relative locations of components along an optical path running from light source 102 to LCD panel 110. For example, in the embodiment depicted in FIG. 1, the optical wedge 104 is disposed optically upstream of the display panel such that light emerging from the optical wedge backlights the display panel. Likewise, the display panel is located optically between the light sources and the light valve panel.

Light source 102 comprises one or more light sources, such as white LEDs or colored LEDs, configured to direct a beam or beams of light of a desired shape and intensity into optical wedge 104. Light propagates through optical wedge 104 via total internal reflection, and is internally reflected from a thick end (not shown) of optical wedge 104 back toward light source 102. The thick end of the optical wedge is configured to direct light back toward light source 102 in such a manner that light emerges from a major surface of the optical wedge (e.g. top or bottom face with reference to the wedge orientation shown in FIG. 1) at a critical angle of reflection as a collimated beam. As described in more detail below, the collimated light is then redirected toward the LCD panel 110, and separated into color bands, as indicated schematically by arrows 114, via diffraction grating 106. Lens array 108 then focuses colored light bands through corresponding color filters of LCD panel 110 (in embodiments where such color filters are used). For example, where white light is separated by diffraction grating 106, red, green and blue light bands may be focused through respective red, green and blue color filters. Where the lines of diffraction grating 106 are oriented parallel to the direction of the color filters of the LCD panel, the color bands will be oriented parallel to the color filters. While the depicted optical wedge 104 is configured to receive light at a thin end and to internally reflect light from a thick end, it will be understood that any other suitable wedge with any other suitable optical configuration may be used. Further, in the schematic view of FIG. 1, diffraction grating 106 is illustrated as both turning incident light toward LCD panel 110 and separating incident light into a plurality of bands of colored light. However, as described below, in some embodiments, a turning film, such as a refractive or reflective array, may be used to turn light toward the LCD panel.

In embodiments that utilize white light sources, the use of a diffraction grating in combination with white light sources may offer various advantages over the use of colored light sources. For example, white light sources may be less expensive than colored light sources. Further, as mentioned above, the diffraction grating may be oriented relative to the color filters of an LCD panel such that bands of colored light formed by the diffraction grating are oriented parallel to the color filters. This may allow a band of colored light to be focused onto a color filter of the same color, and thereby may help to preserve a brightness of an image displayed on the LCD panel compared to the use of white light of a similar intensity without such a diffraction grating.

Likewise, in embodiments that utilize colored light sources, the use of a diffraction grating may help to reduce optical aberration caused by a reflective lens within an optical wedge (e.g. at the thick end of the wedge). More specifically, a diffraction grating may be used to increase a fan-out angle of light emerging from an optical wedge. This may allow an internally reflective lens formed in a thick end of the wedge to be configured with a longer focal length such that the fan-out angle in the wedge is decreased. Because larger, shorter focal length lenses can cause more optical aberration than smaller, longer focal length lenses, the use of a diffraction grating in such embodiments may help to reduce optical aberration in the backlight system. As mentioned above, it will be understood that, in embodiments that utilize colored light, color filters may be omitted where suitable.

The diffraction grating may have any suitable location within an optical path of an optical wedge backlighting system, and may have any suitable configuration of diffractive elements suitable for forming a desired pattern of colored lines. For example, in some embodiments, only a first order of diffracted light may be used for image production, while in other embodiments, higher orders may also be used.

A diffraction grating may be positioned at any suitable location in the optical path of a wedge backlighting system. For example, in some embodiments, a diffraction grating may be provided as a film that is spatially separated from other components in a backlight system. However, such a film may add additional cost to a backlighting system. Therefore, in other embodiments, the diffraction grating may be included with another part in a backlight system.

FIGS. 2-4 show various example embodiments of suitable configurations for optical wedges and diffraction gratings in an optical wedge backlighting system. In the depicted embodiments, the light source(s), lens array(s) and display panels are omitted for clarity. However, it will be understood that such components may be provided in the configuration shown in FIG. 1 relative to the depicted optical wedges and diffraction gratings, or may be provided in any other suitable configuration. It likewise will be understood that these figures are presented for the purpose of example, and are not intended to be limiting in any manner.

First, FIG. 2 shows an embodiment of an optical wedge system 200 configured to emit light internally reflected light from the light sources through its top surface (i.e. a major surface that faces the display panel). Optical wedge system 200 comprises an optical wedge 202, and a turning film 204 coupled to optical wedge 202 via a layer of an adhesive 206. In this embodiment, the turning film is coupled to the optical wedge at the major surface that faces the display panel. Optical wedge system 200 also comprises diffraction grating 208, shown schematically as a series of lines on a surface of turning film 204. Diffraction grating 208 may be formed, for example, by printing a series of lines onto the refractive surfaces of turning film 204 through which light exits the turning film, or may be formed in any other suitable manner. White light incident on turning film 204 and diffraction grating 208 is indicated by arrow 210, while bands of red, green and blue colored light exiting the diffraction grating 208 are indicated at 212.

Combining diffraction grating 208 and turning film 204 into a single part may simplify manufacturing and lower costs relative to forming diffraction grating 208 on a separate film. It will be understood that optical wedge system 200, as well as the other embodiments described herein, may include other structures not shown in FIG. 2. For example, optical wedge system 200 may comprise an optical cladding positioned on either, or both, of the top and bottom surfaces of the wedge (with reference to the orientation of the optical wedge shown in FIG. 2). The use of such a cladding may allow a desired critical angle of internal reflection to be selected based upon the differences between the indices of refraction of the wedge and cladding materials. Further, different cladding materials may be applied to different surfaces of optical wedge 200 so that different surfaces have different critical angles of internal reflection.

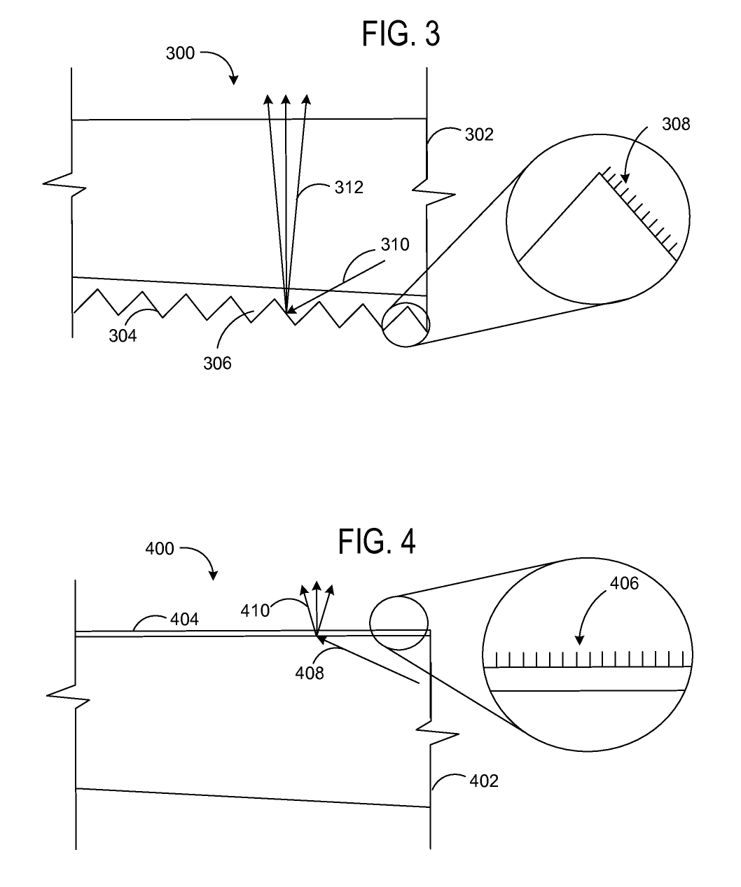

FIG. 3 shows another embodiment of an optical wedge system 300 suitable for use as a backlighting system. In contrast with the embodiment of FIG. 2, optical wedge system 300 is configured to emit internally reflected light from the light sources through a bottom major surface (i.e. the major surface that faces away from the display panel). Optical wedge system 300 includes an optical wedge 302, a turning film 304 coupled to the optical wedge 304 at the major surface that faces away from the display panel, and a diffraction grating 308 disposed on the turning film. Whereas the turning film of the embodiment of FIG. 2 is a refractive turning film configured to transmit light, turning film 306 is configured to reflect light that passes out of the optical wedge back through the optical wedge toward an LCD panel. Example white light incident on diffraction grating 308 is indicated by arrow 310, while red, green and blue bands of light exiting the diffraction grating are indicated at 312. It will be understood that light sources of other colors than white also may be used.

In some embodiments, the diffraction grating itself may also serve as a turning film that redirects light emitted from the optical wedge toward the display panel. This may allow the omission of a separate refractive or reflective turning film, such as those shown in FIGS. 2 and 3, and therefore may help to save costs. FIG. 4 shows an example of such an optical wedge system 400. Optical wedge system 400 comprises an optical wedge 402, a layer of a cladding 404, and a diffraction grating 406 formed on a top surface of the optical wedge (with reference to the orientation shown in FIG. 4) through which light exits the optical wedge toward an LCD panel. Example white light incident on diffraction grating 406 is shown at 408, and bands of red, green and blue colored light exiting diffraction grating 406 are shown at 410. It will be understood that various lenses may be used in conjunction with optical wedge system 400 to adjust the spacings between colored light bands as appropriate for the color filter geometry of a particular LCD panel. As mentioned above, it will be understood that light sources of other colors than white also may be used.

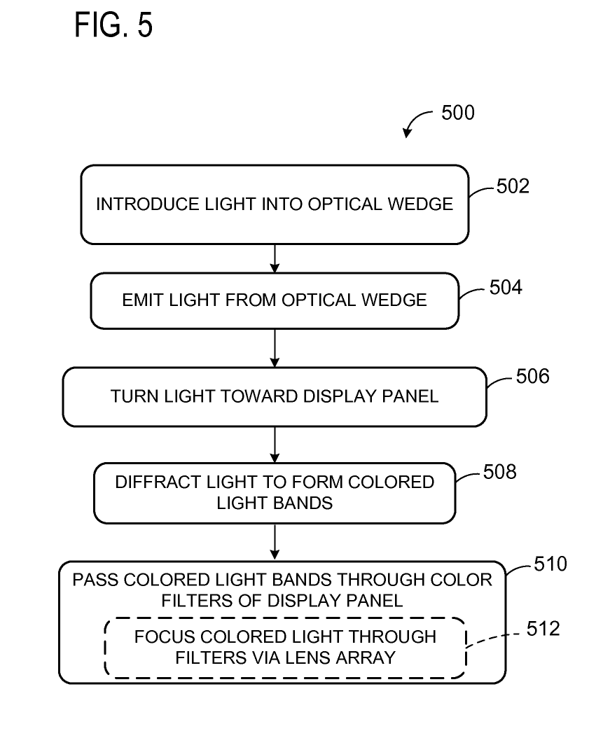

FIG. 5 shows a flow diagram depicting an embodiment of a method 500 of operating a display system. Method 500 comprises, at 502, introducing light from a light source into an optical wedge. In some embodiments, white light may be introduced from one or more white light emitting diodes. In other embodiments, other colors of light than white may be used, and/or other light sources than light emitting diodes may be used. Method 500 next comprises, at 504, emitting the light from the optical wedge, and at 506, turning the light toward a display panel. The light may be emitted either from a face of the optical wedge that faces the display panel, or from a face that faces away from the display panel. In either case, a suitably configured turning film may be used to turn the light toward the display panel. In yet other embodiments, the light is both turned and diffracted via a diffraction grating, as described above.

Method 500 next comprises, at 508, diffracting the light to produce a plurality of bands of light. The light may be diffracted via a diffraction grating positioned in any suitable location within the display system. For example, as described above, the diffraction grating may be located on a turning film, on a separate film from the turning film (either optically upstream or downstream of the turning film), on a surface of the optical wedge, or on a cladding layer disposed on the optical wedge. It will be understood that these specific embodiments are presented for the purpose of example, and are not intended to be limiting in any manner.

After diffracting the light to produce a plurality of bands of colored light, method 500 next comprises, at 510, passing the plurality of bands of colored light through the display panel such that the plurality of bands of colored light pass through corresponding color filters of the display panel. In this manner, in embodiments that utilize white light sources, less light intensity may lost due to color filtering than if white light is passed through the color filters. It will be understood that various other processes may be performed. For example, in some embodiments, the plurality of bands of colored light may be focused through the corresponding color filters of the display panel via a lens array, as indicated at 512.

While described herein in the context of an LCD panel with color filters, it will be understood that the above-disclosed embodiments also may used with any other suitable image-producing panel having color filters for each pixel. It is to be understood that the configurations and/or approaches described herein are described for the purpose of example, and that these specific embodiments or examples are not to be considered in a limiting sense, because numerous variations are possible. For example, a diffraction grating may be disposed at any other suitable location within an optical wedge backlight system other than those described herein. Likewise, an optical wedge backlighting system may have any other suitable configuration relative to a display panel other than those shown herein.

The subject matter of the present disclosure includes all novel and nonobvious combinations and subcombinations of the various processes, systems and configurations, and other features, functions, acts, and/or properties disclosed herein, as well as any and all equivalents thereof.

1. A display panel system, comprising:
a display panel comprising a plurality of pixels;
an optical wedge disposed optically upstream of the display panel such that light emerging from the optical wedge backlights the display panel;
one or more light sources configured to introduce light into the optical wedge; and
a diffraction grating disposed optically between the one or more light sources and the display panel.

2. The display panel system of claim 1, wherein the diffraction grating is located optically between the optical wedge and the display panel.

3. The display panel system of claim 2, wherein the optical wedge is configured to emit internally reflected light from the one or more light sources through a major surface that faces the display panel, wherein a turning film is coupled to the optical wedge at the major surface that faces the display panel, and wherein the diffraction grating is formed on the turning film.

4. The display panel system of claim 2, wherein the optical wedge is configured to emit internally reflected light from the light sources through a major surface of the optical wedge that faces away from the display panel, wherein a turning film is coupled to the optical wedge at the major surface that faces away from the display panel, and wherein the diffraction grating is formed on the turning film.

5. The display panel system of claim 2, wherein the diffraction grating serves as a turning film that redirects light emitted from the optical wedge toward the display panel.

6. The display panel system of claim 1, wherein the one or more light sources comprise white light sources.

7. The display panel system of claim 6, wherein the display panel further comprises a plurality of color filters arranged in columns that run parallel to a short dimension of the display panel, and wherein the lines of the diffraction grating run in a direction parallel to the color filters.

8. The display panel system of claim 1, wherein the display panel is a liquid crystal display panel.

9. The display panel system of claim 1, wherein the optical wedge has a direction of taper that is parallel to a long dimension of the display panel.

10. The display panel system of claim 1, wherein the display panel further comprises a plurality of color filters, and wherein the display panel system further comprises a lens array configured to focus colored light from the diffraction grating through the color filters.

11. The display panel system of claim 1, wherein the display panel system is configured to utilize a first order of diffracted light and one or more higher orders of diffracted light for image production.

12. The display panel system of claim 1, wherein the display panel system is configured to utilize only a first order of diffracted light for image production.

13. A liquid crystal display system, comprising:
a liquid crystal display panel comprising a plurality of pixels, each pixel comprising a plurality of color filters;
an optical wedge disposed optically upstream of the liquid crystal display panel such that light emerging from the optical wedge backlights the liquid crystal display panel;
a plurality of white light sources each configured to introduce white light into the optical wedge;
a diffraction grating located optically between the optical wedge and the color filters of the liquid crystal display panel; and
a lens array located optically between the diffraction grating and the color filters of the display panel.

14. The display system of claim 13, wherein the optical wedge is configured to emit internally reflected light from the light sources through a major surface that faces the liquid crystal display panel, wherein a turning film is coupled to the optical wedge at the major surface that faces the liquid crystal display panel, and wherein the diffraction grating is formed on the turning film.

15. The display system of claim 13, wherein the optical wedge is configured to emit internally reflected light from the light sources through a major surface of the optical wedge that faces away from the liquid crystal display panel, wherein a turning film is coupled to the optical wedge at the major surface that faces away from the liquid crystal display panel, and wherein the diffraction grating is formed on the turning film.

16. The display system of claim 13, wherein the diffraction grating serves as a turning film that redirects light emitted from the optical wedge toward the liquid crystal display panel.

17. The display system of claim 13, wherein the diffraction grating comprises a plurality of lines, and wherein the color filters are arranged in columns that run parallel to the lines of the diffraction grating.

18. The display system of claim 13, wherein the optical wedge has a direction of taper that is parallel to a long dimension of the display panel.

19. A method of operating a display system, comprising:
introducing white light from a light source into an optical wedge;
emitting the white light from the optical wedge;
turning the white light toward a display panel;
diffracting the white light to produce a plurality of bands of colored light; and
passing the plurality of bands of colored light through the display panel such that the plurality of bands of colored light pass through corresponding color filters of the display panel.

20. The method of claim 19, further comprising focusing the plurality of bands of colored light through the corresponding color filters of the display panel via a lens array.
